(19) United States
(12) Patent Application Publication
(10) Pub. No.: US 2012/0032804 A1
(43) Pub. Date: Feb. 9, 2012

(54) SYSTEM FOR THE LOGISTICAL MONITORING AND CONTROL OF THE FLOW OF GOODS, THEIR STORAGE, STORAGE AND TRANSPORTATION CONDITIONS AND CONSUMPTION

(75) Inventor: Hubert Walter, Neu-Ulm (DE)

(73) Assignee: HW Verwaltungs GmbH, Neu-Ulm (DE)

(21) Appl. No.: 13/262,270

(22) PCT Filed: Mar. 31, 2010
(86) PCT No.: PCT/DE2010/000397

§ 371 Date: Oct. 27, 2011

(30) Foreign Application Priority Data
Mar. 31, 2009 (DE) 102009016539 8

(51) Int. Cl. G08B 13/14

(52) U.S. Cl. 340/572.1

(57) ABSTRACT

The invention relates to a system for the logistical monitoring and control of the flow of goods, their storage, storage and transportation conditions and consumption. At least one electronic data processing and memory unit having a network link which is connected to a central enterprise, monitoring, planning, and control system for transmitting and receiving data and information is present. Further components of the system are a descriptor element for transmitting data from and to a mobile electronic memory element, individual electronic identification elements and intermediate storage positions provided with mobile electronic memory elements and/or containers with reading and/or writing units for RFID and/or barcodes.

The invention relates to a system for the logistical monitoring and control of the flow of goods, their storage and consumption. The invention in particular relates to the area of catering and in this respect very particularly to catering in the aeronautic sector.

There are many deficiencies in the known solutions which result in losses and inefficiencies. Since here the goods, foodstuffs or other supplies such as tableware and duty-free articles are accommodated, stored and transported in trolleys which belong to an owner (caterer or airline), losses of these trolleys occur due to swapping. A tracking has previously not been possible.

The situation is similar with the content of trolleys. It cannot be checked or even reliably logged on the filling. The ultimate localization is also only possible with difficulty after the removal of individual goods or articles and intermediate storage in compartments which are, for example arranged in trays in a kitchen of a vehicle (galley). The storing is namely carried out by different personnel than in the removal for consumption.

A tracking and determination of the instantaneous position of individual goods or trolleys or other containers in which goods can be stored and transported is also not possible with sufficient accuracy and simultaneously in time.

It is therefore the object of the invention to provide a system with which the monitoring and control of the flow of goods, their storage, the storage and transport conditions and consumption can be improved, simplified and made more reliable.

Electronic data processing and memory units are associated with the system which have a network link, which are installed at different relevant locations and which are connected to a central enterprise, monitoring, planning and control system for transmitting and receiving data and information.

There are moreover present at least one electronic data processing and memory units having a network link which is connected to a central enterprise, monitoring, planning and control system for transmitting and receiving data and information and a descriptor element for transferring data from and to a mobile electronic memory elements, individual electronic identification elements and mobile electronic memory elements and intermediate storage positions and/or containers having reading and/or writing units for RFID and/or barcodes.

At least one electronic data processing and memory unit having a network link which is connected to a central enterprise, monitoring, planning and control system for transmitting and receiving data and information is present at a system in accordance with the invention. In addition, a descriptor element for transferring data from and to mobile electronic memory elements, individual electronic identification elements and mobile electronic memory elements and intermediate storage positions and/or containers provided with reading and/or writing units for RFID and/or barcodes are present.

An electronic memory element can be fastened to a container which can be used in a mobile manner or can be installed thereat.

In an electronic memory element usable with a system

a temperature sensor having a programmable auto-log-in function;

an authenticating function for access to stored data;

access security for stored data;

a display;

a writing/reading interface;

and/or an integrated electric energy store or electric energy source can advantageously be present.

In this respect, at least two of these named components should be realized.

A continuous monitoring of the temperature and thus the observation of the refrigerating chain and a record thereof can be made using a temperature sensor. An HACCP tracking system can thus be provided.

On the picking of the goods to be distributed, an optical and/or acoustic information element can be present for the picker to communicate to him what should be picked in which form to where (optionally for whom). This can be an optical display element (screen) or a loudspeaker.

An actuation element, e.g. a switch/push button (buzzer) for confirming the carrying out of the acoustically or optically presented work instruction should be present at a picking station. This can be done with the aid of a switch or also by touchscreen at the above-named display element/monitor.

The picking station can have a descriptor element for transmitting data from and to a mobile electronic memory element. This descriptor element (writer) can transmit data and information via a data line or also wirelessly. Two optical displays (e.g. diodes) should be present, or analog optically, for confirming the respective writing procedure or data transfer procedure.

A unit should be at the picking station with which the respective picker working there can be identified. This unit only releases the workplace after recognition of the picker. This identification can be achieved inductively, capacitively, by means of RFID, magnetic card, bioscan, or similar or via conventional electrical or electronic contacts.

A unit for detecting the designated trolleys/receptacles/containers to be supplied is present at this station. This can take place using RFID technology and/or the utilization of barcodes. RF or UHF transmission can preferably be used with RFID and a barcode, one-dimensional or multi-dimensional.

An uninterrupted power supply should be present at this station. Battery buffering can, for example, be provided for any autonomy of energy which may be required.

A fixed interface to a mobile electronic data processing and memory unit (hand-held) should also be present there.

Data/information can be transmitted to and from the station via a network interface in a wired or wireless manner to a higher ranking system either directly or via a middleware application.

Data of the central enterprise, monitoring, planning and control system (ERP) can be correspondingly visualized or represented acoustically by software for the station and the confirmation of completed jobs can be sent back in parallel. The software can have an integrated user permission management or a link to external software is present for managing the permissions and user profiles.

The confirmation of the carrying out of an action on the packing by actuation of the actuation element can either be buffered and then passed on or can be led directly to the central enterprise, monitoring, planning and control system.

It is particularly advantageous here to allow the possible identification, the direct access to the central enterprise, monitoring, planning and control system and the subsequent copying of the data into a data memory which can be formed as a “virtual backbone” or also as a mobile data memory.

In additional individual electronic user identification elements which can also be called a personal stick can be a component of the system. They can be connected to the aforesaid descriptor unit in a suitable mechanical/electromechanical manner. The identification can take place, for example inductively, capacitively, by means of RFID, magnetic card, bioscan or similar or via conventional contacts. The user/worker can carry it with him, like a company ID.

Mobile electronic memory elements which have at least one interface are also present in this system. They can also be called memory sticks. To avoid theft, an electromechanical interface can be present which is made differently than common standards. It can be formed round or polygonal, in differing sizes, for this purpose.

Such a memory element should now have a clear—preferably non-changeable—identification code/number. Static content (e.g. processing stations, potential work and/or storage instructions, parameters specific to use (flight time, galley, aircraft number, . . . )) can be stored in a further memory element having a sufficiently large memory area. Dynamic content should also be able to be stored. It can be used, e.g. parameterized over time, to log the throughput times, the optional temperature/time parameters.

The mobile electronic memory element can additionally have a possibility for an integrated time base. It can obtain its additional energy either in that an internal energy store is filled on each writing/reading. A capacitor can be used for this purpose. The use of a small solar cell, as an example for an electrical energy source, is, however, more favorable. A constant T-t log-in can hereby be made possible permanently and maintenance free.

Optionally, a tagging can take place via an internal “RFID tag”, preferably RF or UHF, using a mobile electronic memory element. A possibility can also be present for an exclusive or additional tagging by barcode, 1D or multi-dimensionally, which can be attached to the outside of trolleys or containers in a robust and resistant manner. A replacement for conventional labels printed on paper or cardboard can thereby be provided. An acoustic identification can also take place.

A holder for printed labels can also be present on memory elements. It is favorable to provide an electrical, electromechanical or electronic warning lock at a mobile electronic memory element. This means that an employee identification analog to the picking station is possible at the memory element. If the “warning lock” is opened without an authorized employee doing it, a warning signal can be generated optically/acoustically and/or the unauthorized access can be stored.

A display element which can be anchored in a housing can be present at the memory elements. It is preferably a bistable display.

Intermediate storage positions, which are frequently also called ramps, can also associated with the system. Work should also be carried out independent of the mains network there. For this purpose, an emergency supply or a suitable electrical energy store can be present.

On use of RFID technology, free magnetic field influence should be observed. With barcodes, laser-based units can result in serious retinal damage. It is therefore advantageous to provide a safety circuit which only allows the release when a device/trolley/container is in the critical zone of the intermediate store. Detectors are present for recognition which carry out an activation of writing and/or reading devices on the approach and recognition of a trolley/container. This can take place inductively, capacitively, optically or via weight measurement. If not required, no electromagnetic fields are therefore active or a laser of a reading device is switched off.

If RFID technology is used, a shielding housing can also be present. On use of a laser, a limiting oppositely disposed protective wall can be provided.

Electronic image recognition systems can be used for multi-dimensional barcodes. In these cases, the use of corresponding detectors can likewise be provided for the establishment of adequate safety and to avoid permanent scanning.

On the use of image recognition systems (imagers), a combination with RFID technology should be provided. A possibility should be present at intermediate stores for the buffering of recorded data and/or a visual display possibility. Data recording can be direct or indirect (that is buffered) and forwarded via a standard interface to mobile electronic data processing and memory units. It is preferably a fixed contact, with it being able to be designed robustly via IP 56. The data transfer can, however, also take place wirelessly.

A weighing device with weight recording can also be present at an intermediate store. The determined individual masses associated with the respective containers/trolleys can be communicated to the central enterprise, monitoring planning and control system. This information can also be directed via an interface of the mobile electronic memory element.

The total goods mass can hereby be unambiguously determined and already results in an approximate advance comparison with the nominal status, but can in particular influence the load management.

On the use of RFID technology, at least two or more antennas should be present so that a bulk detection becomes possible since frequently containers or other goods reception means are stacked on trolleys.

The RFID labels should preferably be attached to the base of trolleys or containers. They can thereby be protected better and the data transmission can be made more secure.

Further mobile electronic data processing and storage units can be used for a caterer/transporter. They should allow parallelism between the reading of data/information and their storage.

In this respect, the reading of the storage location or of the instantaneous position (independently of the storage location, which can here, by way of example, be the galley) can take place first and then the identification or recognition of the content of a trolley or container. This can be solved dependent on the situation by the software or hardware.

In the case of a software solution, the storage location has to be divided into “sections” (e.g. compartments) which were separated in advance and individually encoded (RFID and/or barcode).

For instance, a user/operator can select the compartment he proposes on a screen (for example via touchscreen) and he subsequently reads either the product identification code or the associated memory content of the mobile electronic memory element.

However, the compartment can also not be selected by software, but rather he scans it via a reading unit (reader) (barcode or RFID coded).

Information can thus be added quasi simultaneously. A compartment can unambiguously be associated with a storage unit and thus with a content or at least an identification code. For an identification code, the central enterprise, monitoring, planning and control system knows which content is behind it.

A reading unit (RFID or barcode) can be fastenable to a body part of an operator. This can be done in the form of a reduced glove, for example.

A mobile electronic memory element can be fastened to an arm part. An operator can thereby read/scan the compartment with the one hand, while he removes the mobile electronic memory element in parallel and inserts it into the reading unit on the arm. The data can be forwarded quasi instantaneously to a mobile electronic data processing and memory unit.

In the case of a wireless data transmission, a protocol and/or transport unit can therefore be present behind the RFID and/or barcode compartment reading unit.

A reading unit can be fastened to a glove and then the transfer unit which transfers the data to the mobile electronic data processing and memory unit.

Mobile electronic data processing and memory units are also provided for issuing personnel (crew).

As a special feature of these mobile electronic data processing and memory units “crew”, a nominal status/nominal content can be stored which can be synchronized with other mobile electronic data processing and memory units. The nominal/actual comparison can thereby take place and a real-time inventory/stock-taking is possible. The synchronization can take place manually, on the one hand, by a “master stick” which was completed at the end of the catering process by one or more of the caterers (persons not companies); on the other hand by a direct synchronization. The data transfer can take place by sound, infrared or radio.

1. A system for the logistical monitoring and control of the flow of goods, their storage, storage and transportation conditions and consumption, said system comprising:
at least one electronic data processing and memory units having a network link which is connected to a central enterprise, monitoring, planning and control system for transmitting and receiving data and information;
a descriptor element for the transmission of data from and to a mobile electronic memory element;
individual electronic identification elements;
mobile electronic memory elements; and
intermediate storage positions and/or containers with reading and/or writing units for RFID and/or barcodes.

2. The system in accordance with claim 1, wherein an electronic memory element is fastenable to a container usable in a mobile manner or is installed thereat.

3. The system in accordance with claim 1, wherein at least one of the following features is/are present at an electronic memory element:
a temperature sensor having a programmable auto-log-in function;
an authenticating function for access to stored data;
access security for stored data;
a display, preferably bistable;
a writing/reading interface; and/or
an integrated electric energy store or electric energy source.

4. The system in accordance with claim 1, wherein an actuation element for confirming the carrying out of acoustically or optically presented work instructions is present at a picking station.

5. The system in accordance with claim 1, wherein an interface which is formed differently from common standards is present at mobile electronic memory elements.

6. The system in accordance with claim 1, wherein the interface is formed round or polygonal in differing sizes.

7. The system in accordance with claim 1, wherein detectors are present at intermediate storage positions which carry out an activation of writing and/or reading devices on the approach and recognition of a trolley/container.

8. The system in accordance with claim 1, wherein a weighing device with weight recording is present at intermediate stores.

9. The system in accordance with claim 1, wherein a reading unit is fastenable to a body part of an operator.

10. The system in accordance with claim 9, wherein a reading unit can be fastened to a glove or to a glove-like element on an operator.

11. The system in accordance with claim 1, wherein a safety circuit is present for releasing reading and/or writing devices on a recognition of devices/trolleys/containers present in a critical zone.
